(19) United States
(12) Patent Application Publication
(10) Pub. No.: US 2024/0300131 A1
(43) Pub. Date: Sep. 12, 2024

(54) METHOD FOR SEGMENTING A PART COMPRISING A PLURALITY OF THIN ELEMENTS SEPARATED BY INTERSTICES

(71) Applicant: ADDUP, Cebazat (FR)

(72) Inventors: JEAN-BAPTISTE MOTTIN, Cebazat (FR); ROMAIN COURANT, Cebazat (FR)

(21) Appl. No.: 18/281,483

(22) PCT Filed: Feb. 28, 2022
(86) PCT No.: PCT/FR2022/050355

§ 371 Date: Sep. 11, 2023

(30) Foreign Application Priority Data
Mar. 12, 2021 (FR) FR2102478

(51) Int. Cl. B26D 3/00; B26D 3/16; B33Y 10/00

(52) U.S. Cl. CPC B26D 3/006; B26D 3/164; B33Y 10/00

(57) ABSTRACT

A method, for segmenting a part (10) comprising a plurality of thin elements (12) separated by interstices (30), the thin elements being in the form of thin walls (14) having a thickness of less than 1 millimetre and/or thin strands having a cross-section of less than 4 square millimetres, comprises the following steps, in order: a) filling the interstices located between the thin elements of the part to be segmented with a filling material, b) segmenting the part into a plurality of portions by segmenting said thin elements, and c) removing the filling material from the segmented portions.

### FIELD OF THE INVENTION AND PRIOR ART

The present invention relates to the segmenting of parts comprising a plurality of thin elements spaced apart from each other and possibly intersecting.

More specifically, the invention is perfectly applicable to the segmenting of parts that are manufactured using an additive manufacturing method such as additive manufacturing by powder layer deposition and at least partially made up of a structure composed of thin walls or thin strands.

Additive manufacturing by powder layer deposition is a manufacturing method in which objects are manufactured by the selective consolidation of different layers of additive manufacturing powder superposed on each other on top of a support such as a manufacturing plate. The consolidation is said to be selective because only zones of the powder layers that correspond to the sections of the objects to be manufactured are consolidated. In the case of metallic powders, the selective consolidation is obtained by complete or partial melting (sintering) of the grains of powder. The selective melting can be obtained using one or more laser beams (Selective Laser Melting®) and/or one or more electron beams (Electron Beam Melting®).

At the start of a method for additive manufacturing by powder layer deposition and selective melting, a first powder layer is uniformly distributed on the plate using a device such as a blade or roller mounted on a carriage that is translatably movable above the manufacturing plate. Then, this first powder layer is selectively melted, for example using a laser beam and/or an electron beam. Next, a second powder layer is uniformly distributed on top of the first powder layer that has just been selectively melted, and this second powder layer is then selectively melted. As many powder layers as are necessary to complete the manufacturing of the object(s) to be manufactured are thus uniformly distributed on top of each other and selectively melted.

Additive manufacturing by powder layer deposition is particularly suitable for manufacturing parts comprising a plurality of thin elements spaced apart from each other and possibly intersecting.

Additive manufacturing by powder layer deposition makes it possible to manufacture monolithic parts comprising thin walls with a thickness of less than 1 millimetre, or even equal to 0.1 millimetre, or strands with a cross-section of less than 4 square millimetres. For example, parts with this type of structure made up of thin walls or thin strands can be used to produce heat exchangers, filters or catalysts.

For various reasons, it can be necessary to segment the parts comprising these thin walls or thin strands after they have been manufactured.

However, during segmenting and because they are so thin, the thin walls or thin strands tend to be deformed by the segmenting tool and flashes can obstruct the interstices separating the thin walls or the thin strands. These flashes and deformations of the thin walls or thin strands must be avoided, as they reduce the geometric quality of the manufactured part and can impair the future functions of this part.

WO2020207969 describes a method for separating objects manufactured using an additive manufacturing method on a manufacturing plate. This method makes provision for immobilizing these objects relative to each other during and after a segmenting step aimed at detaching these objects from the plate on which they were manufactured. The aim of immobilizing the objects relative to each other is to avoid them colliding with each other after they have been separated from the plate, and this immobilization is obtained with at least one layer of a material that can pass from a liquid state to a solid state and vice versa. However, WO2020207969 does not relate to segmenting a single object or an object comprising thin walls or thin strands. In particular, WO2020207969 does not relate to segmenting parts that have already been separated from the plate on which they were manufactured.

### OBJECTIVES OF THE INVENTION

The objective of the present invention is to provide a method capable of preserving the geometric quality and future functions of a part comprising a plurality of thin elements, such as walls or strands, during the segmenting of this part.

Advantageously, the segmenting method according to the invention is applicable both to segmenting a part still rigidly connected to the plate on which it was manufactured, and to segmenting a part that has already been separated from its manufacturing plate, for example using the method described in WO2020207969.

### SUMMARY OF THE INVENTION

To this end, the invention relates to a method for segmenting a part comprising a plurality of thin elements separated by interstices, the thin elements taking the form of thin walls with a thickness of less than 1 millimetre and/or thin strands with a cross-section of less than 4 square millimetres.

According to the invention, the method comprises the following steps taken in chronological order:
a) filling the interstices situated between the thin elements of the part to be segmented with a filling material,
b) segmenting the part into a plurality of portions by segmenting said thin elements,
c) removing the filling material from the segmented portions.

During the segmenting, the filling material supports the thin elements, thus avoiding the deformation thereof and the creation of flashes.

Advantageously, the invention can also provide that:
the thin elements extend in the same direction without crossing, or the thin elements extend in the same direction and intersect each other, for example so as to form a two- or three-dimensional lattice,
two adjacent and non-secant thin elements are situated less than 1 millimetre apart,
when the thin elements take the form of thin walls, the thickness of these thin walls is between 0.05 millimetres and 0.25 millimetres, and preferably between 0.09 and 0.11 millimetres,
when the thin elements take the form of thin strands, the cross-section of these thin strands is between 1 square millimetre and 3 square millimetres, and preferably between 2 and 3 square millimetres,
the segmenting is carried out with a mechanical tool such as a saw blade,
the filling material is in a liquid state during step a) and a solid state during step b),
the filling material passes back to a liquid state during step c),
the filling material passes from a liquid state to a solid state, and conversely from a solid state to a liquid state, under the effect of a temperature change,
the filling material has a solidification temperature and a melting temperature of between 45° C. and 100° C.,
the filling material is water or wax,
the filling material has a solidification temperature and a melting temperature of between 100° C. and 250° C.,
the filling material is a low melting point metal or metal alloy,
the filling material passes from a liquid state to a solid state through a chemical reaction,
the filling material is destroyed, for example by combustion or chemical attack, during the removal thereof from the segmented portions,
the filling material is a polymerizable resin,
the filling material is in a mushy state during step a) and a solid state during step b),
the filling material is a thermoforming resin.

The invention also relates to a method for manufacturing at least one part comprising a plurality of thin elements separated by interstices, the thin elements taking the form of thin walls with a thickness of less than 1 millimetre and/or thin strands with a cross-section of less than 4 square millimetres, the method for manufacturing said part being an additive manufacturing method and the part thus manufactured being segmented after manufacturing using the segmenting method according to the invention.

This manufacturing method can also make provision for manufacturing a plurality of parts comprising a plurality of thin elements separated by interstices, the method comprising the following steps taken in chronological order:
additive manufacturing of a single body grouping together the different parts to be manufactured,
use of the segmenting method according to the invention to segment the different parts from said body.

This manufacturing method can also make provision for a part or body to be segmented to be initially manufactured using an additive manufacturing method by powder layer deposition and selective consolidation of each powder layer.

### DESCRIPTION OF THE FIGURES

Further features and advantages of the invention will become apparent from the following description. This description, which is given by way of non-limiting example, refers to the appended drawings, in which:

FIG. 1 shows a perspective schematic view of a first example of a part comprising a plurality of thin elements separated by interstices,

FIG. 2 shows a perspective schematic view of a second example of a part comprising a plurality of thin elements separated by interstices,

FIG. 3 shows a perspective schematic view of a third example of a part comprising a plurality of thin elements separated by interstices,

FIG. 4 shows a cross-sectional view of a part before the introduction of a filling material,

FIG. 5 shows a cross-sectional view of a part after the introduction of a filling material,

FIG. 6 shows a perspective view of two portions segmented from a part using the segmenting method according to the invention,

FIG. 7 shows a perspective view of the segmenting of a plurality of parts from a single body using the segmenting method according to the invention.

### DETAILED DESCRIPTION

The invention relates to the segmenting of parts comprising a plurality of elements separated by interstices.

More specifically, the invention particularly relates to the segmenting of parts that are manufactured using an additive manufacturing method such as additive manufacturing by powder layer deposition and at least partially made up of a structure composed of thin walls or thin strands.

Segmenting is given to mean mechanical segmenting during which a tool, such as a saw blade, is used to separate a part or a body into a plurality of portions.

### First Example of a Part

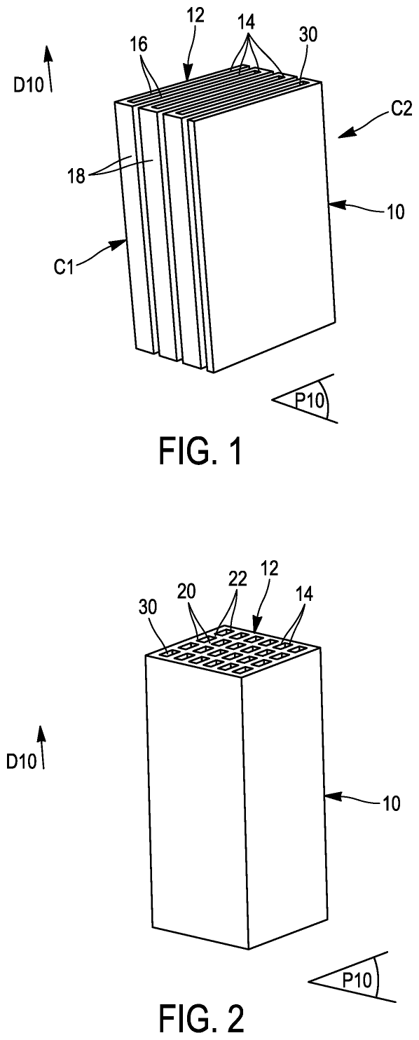

FIG. 1 illustrates a first example of a part 10 that can advantageously be segmented using the method according to the invention.

In this first example, the part 10 comprises a plurality of thin elements 12 that take the form of thin walls 14. Thin walls is given to mean walls the thickness of which is less than 1 millimetre, for example the thickness of which is between 0.05 millimetres and 0.25 millimetres, and preferably between 0.09 and 0.11 millimetres.

In this first example, the thin walls rise from a reference plane P10 corresponding for example to the plane of the manufacturing plate on which the part is manufactured using an additive manufacturing method such as additive manufacturing by powder layer deposition and selective consolidation of these powder layers.

In this first example, the thin walls 14 of the part 10 extend without crossing in the same reference direction D10, which can correspond for example to the direction in which the part is manufactured layer by layer.

In this first example, the thin walls 14 extend orthogonally to the reference plane P10 without crossing. However, the thin walls 14 are connected to each other by their ends so as to form a single part 10. A first group of wide thin walls 16 thus extend parallel to each other, and a second group of narrower thin walls 18 extend parallel to each other and orthogonally to the wide thin walls in the first group. More specifically, a narrower thin wall connects two adjacent wide thin walls. Yet more specifically, the wide thin walls are alternately connected by a narrower thin wall situated on a first side C1 of the part and by a narrower thin wall situated on a second side C2 of the part.

In this first example, two adjacent wide thin walls are situated less than one millimetre from each other, but at a non-zero distance in order to leave an interstice 30 between them. The interstices 30 make it possible for example for the part 10 to act as a filter, catalyst or heat exchanger.

### Second Example of a Part

FIG. 2 illustrates a second example of a part 10 that can advantageously be segmented using the method according to the invention.

In this second example, the part 10 also comprises a plurality of thin elements 12 that take the form of thin walls 14. Again, thin walls is given to mean walls the thickness of which is less than 1 millimetre, for example the thickness of which is between 0.05 millimetres and 0.25 millimetres, and preferably between 0.09 and 0.11 millimetres.

In this second example, the thin walls also rise from a reference plane P10 corresponding for example to the plane of the manufacturing plate on which the part is manufactured using an additive manufacturing method such as additive manufacturing by powder layer deposition and selective consolidation of these powder layers.

In this second example, the thin walls 14 of the part 10 intersect each other and extend in the same reference direction D10, which can correspond for example to the direction in which the part is manufactured layer by layer.

In this second example, the thin walls 14 extend orthogonally to the reference plane P10. In addition, each thin wall 14 intersects with a plurality of other thin walls. First thin walls 20 in a first group thus extend parallel to each other, and second thin walls 22 in a second group extend parallel to each other and orthogonally to the first thin walls. More specifically, each thin wall 20 in the first group intersects with all of the thin walls in the second group and likewise, each thin wall in the second group intersects with all of the thin walls in the first group. The thin walls thus form a two-dimensional lattice.

In this second example, two adjacent wide thin walls are situated less than one millimetre from each other, but at a non-zero distance in order to leave an interstice 30 between them. In this second example, the interstices 30 form ducts with a small cross-section, for example between 1 square millimetre and 1.5 square millimetres, and they make it possible for example for the part 10 to act as a filter, catalyst or heat exchanger.

### Third Example of a Part

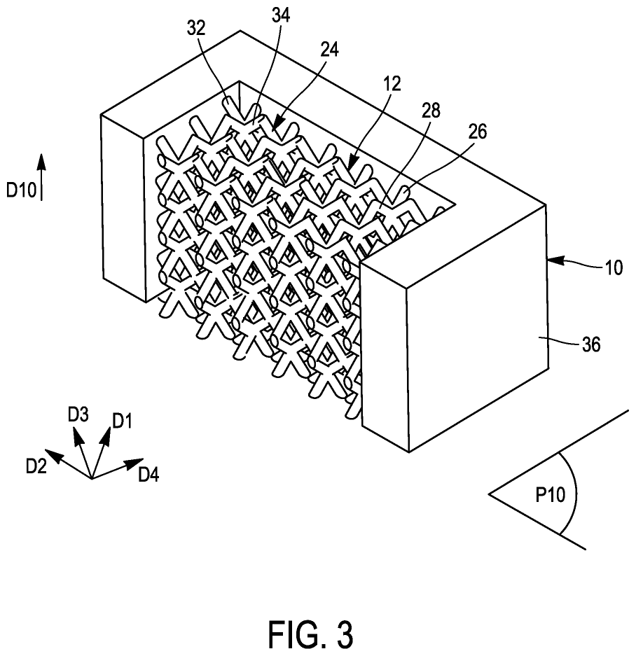

FIG. 3 illustrates a third example of a part 10 that can advantageously be segmented using the method according to the invention.

In this third example, the part 10 comprises a plurality of thin elements 12 that take the form of thin strands 24. Thin strands is given to mean strands the cross-section of which is between 1 square millimetre and 3 square millimetres, and preferably between 2 and 3 square millimetres.

In this third example, the thin strands 24 also rise from a reference plane P10 corresponding for example to the plane of the manufacturing plate on which the part is manufactured using an additive manufacturing method such as additive manufacturing by powder layer deposition and selective consolidation of these powder layers.

In this third example, the thin strands 24 of the part 10 intersect each other and extend in directions that are different from each other and different from the reference direction D10, which can correspond for example to the direction in which the part is manufactured layer by layer.

In this third example, the thin strands 24 extend in four directions D1, D2, D3, D4 orthogonal to each other. Each thin strand extending in one of these four directions intersects with three other thin strands that extend respectively in each of the other three directions. First thin strands 26 in a first group thus extend parallel to each other in the first direction D1, second thin strands 28 in a second group extend parallel to each other in the second direction D2, third thin strands 32 in a third group extend parallel to each other in the third direction D3, and fourth thin strands 34 in a fourth group extend parallel to each other in the fourth direction D4. The thin strands thus form a three-dimensional lattice.

In this third example, two adjacent, parallel thin strands are situated at a distance of between 5 and 8 millimetres relative to each other, but at a non-zero distance in order to leave an interstice 30 between the different strands. In this third example, the interstices 30 are substantially cubic and are connected to each other. The three-dimensional lattice formed by the thin strands makes it possible for example for the part 10 to act as a filter, catalyst or heat exchanger.

In this third example of a part 10, the network of thin elements 12 is partially surrounded by a solid wall 36 that is thicker than the thin elements 12. The invention can advantageously and equally be applied to the parts 10 comprising thin elements not surrounded by a solid wall, or completely or partially surrounded by a solid wall.

In any of the three preceding examples, and in a plane parallel to the reference plane P10, the ratio between the total surface area of the part, that is, the surface area contained inside the outer outline of the part, and the cumulative surface area of the sections of the different strands and/or of the different walls solidified by melting is greater than five, and preferably greater than eight.

### Segmenting Method

The segmenting method according to the invention is particularly suitable for segmenting parts such as those described above with a mechanical tool such as a saw blade.

In order to implement such segmenting, the segmenting method according to the invention comprises the following steps taken in chronological order:
a) filling the interstices situated between the thin elements of the part to be segmented with a filling material,
b) segmenting the part into a plurality of portions by segmenting said thin elements,
c) removing the filling material from the segmented portions.

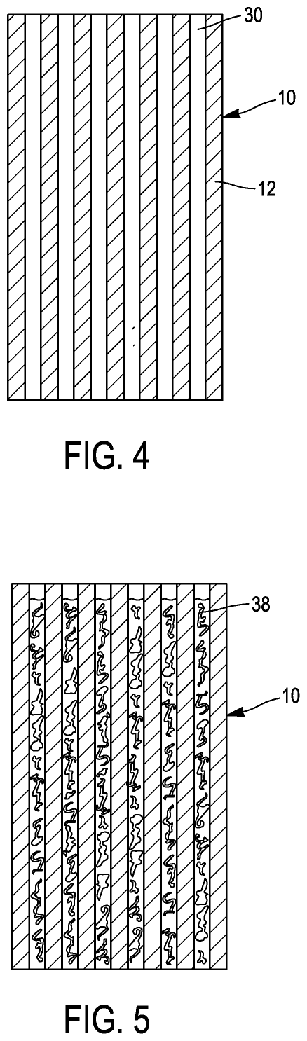

FIGS. 4 and 5 illustrate the step of filling the interstices 30 situated between the thin elements 12 of the part to be segmented with a filling material 38.

The filling material 38 is a material that can be deformed or is capable of deforming in order to easily penetrate, in particular by gravity, the interstices 30 of a part 10. The filling material makes it possible to hold the thin walls and/or the thin strands during the segmenting of the part.

### First Embodiment of the Segmenting Method

In a first embodiment of the method according to the invention, and in order to facilitate the penetration of the filling material 38 into the interstices 30 of the part 10, the invention provides that the filling material is in a liquid state during step a). Liquid state is given to mean a state in which the filling material has sufficient viscosity to be introduced easily, in particular by gravity, into the interstices 30 of a part 10 to be segmented.

For example, a material that can take the form of a gel can be used as a filling material. In this case, the filling material can also be injected under pressure into the interstices of the part.

Next, for the implementation of step b), the filling material is brought to a solid state. This filling material thus offers a certain stiffness that allows it to hold the thin elements during segmenting and avoid the appearance of flashes.

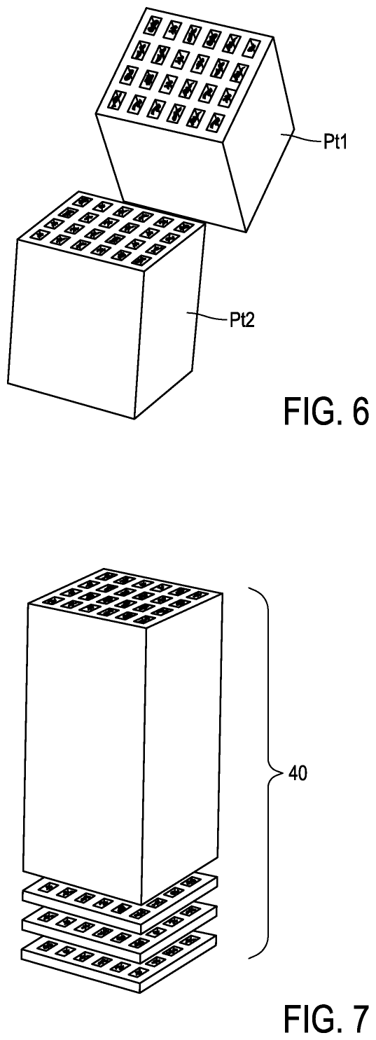

FIG. 6 shows two portions Pt1, Pt2 segmented cleanly from a part 10 due to the filling material present in the interstices 30.

Still in this first embodiment of the method according to the invention, the filling material is returned to a liquid state during step c).

Having become liquid again during step c), the filling material can simply be removed from the segmented portions by gravity. Optionally, a liquid or gaseous fluid, for example pressurized, can be used to drive the liquid filling material from the interstices 30.

In this first embodiment, the filling material passes from a liquid state to a solid state, and conversely from a solid state to a liquid state, under the effect of a temperature change. This reversible change of state of the filling material under the effect of a temperature change facilitates the implementation of the segmenting method.

In greater detail, the filling material passes from a solid state to a liquid state by heating and from a liquid state to a solid state by cooling.

In a first example, the filling material has a solidification temperature and a melting temperature of between 45° C. and 100° C., for example between 55° C. and 75° C., and for example between 59° C. and 61° C. In this first example, the filling material can be a wax, such as a mineral wax like paraffin. A wax offers solidification and melting temperatures generally between 45° C. and 75° C.

The wax in a liquid state, therefore heated in advance, can be poured onto the part in order to fill the interstices 30 by gravity. Alternatively, the part and optionally the plate on which it was manufactured is/are submerged in a bath of wax in a liquid state, therefore heated in advance. Once the wax has been introduced into the interstices of the part, the wax and the part are cooled so that the wax gradually returns to its solid state. If the part is open in several locations, one or more plugs can be attached to the part to contain the wax inside the part during the cooling and solidification thereof. Once the wax has solidified, the part can be segmented. Finally, once the segmenting has been carried out, the wax contained in the segmented portions is heated again in order to return to a liquid state and be removed by gravity from the interstices of the segmented portions.

In a second example, the filling material is water. The water passes to a solid state when it is brought below approximately 0° C. (at sea level) and to a liquid state when it is brought above approximately 0° C. (at sea level).

The water in a liquid state, therefore at a temperature above 0° C., can be poured onto the part in order to fill the interstices 30 by gravity. Alternatively, the part and optionally the plate on which it was manufactured is/are submerged in a bath of water in a liquid state. Once the water has been introduced into the interstices of the part, the water contained in the part is cooled to a temperature below 0° C. and gradually passes to its solid state. If the part is open in several locations, one or more plugs can be attached to the part to contain the water inside the part during the cooling and solidification of the water. Once the water has turned into ice, the part can be segmented. Finally, once the segmenting has been carried out, the ice contained in the segmented portions is heated so that the water returns to a liquid state and is removed by gravity from the interstices of the segmented portions. In a third example, the filling material has a solidification temperature and a melting temperature of between 100° C. and 250° C. In this third example, the filling material can be a low melting point metal or metal alloy. For example, the filling material is or comprises tin or another post-transition metal.

The low melting point metal or alloy heated to a liquid state can be poured onto the part in order to fill the interstices 30 by gravity. Once the metal or metal alloy in a liquid state has been introduced into the interstices of the part, the part is cooled so as to return bring the metal or metal alloy towards its solid state. If the part is open in several locations, one or more plugs can be attached to the part to contain the metal or metal alloy inside the part during the cooling and solidification thereof. Once the metal or metal alloy has solidified, the part can be segmented. Finally, once the segmenting has been carried out, the part is heated so that the metal or metal alloy returns to a liquid state and is removed by gravity from the interstices of the segmented portions.

### Second Embodiment of the Segmenting Method

In a second embodiment of the method according to the invention, the filling material passes from a liquid state to a solid state through a chemical reaction. In this case, the filling material is destroyed, for example by combustion or chemical attack, during step c). For example, the filling material is a polymerizable resin, and the polymerization can be thermally or chemically induced.

### Third Embodiment of the Segmenting Method

In a third embodiment of the method according to the invention, the filling material is in a mushy state during step a) and a solid state during step b). Mushy state is given to mean a malleable state, with a viscosity less than that of a gel, but sufficient to make it possible to insert the filling material into the interstices of the part. In this case, the filling material can also be injected under pressure into the interstices of the part. For example, the filling material is a thermoforming resin that becomes mushy above a certain temperature and becomes solid again below this same temperature or below another temperature. For example, the thermoformable resin passes to a mushy state when it is brought to a temperature of between 50° C. and 70° C., and returns to a solid state when it is cooled to below a temperature between 50° C. and 70° C.

In this third embodiment, once the part has been segmented, the thermoforming resin can be heated again in order to be removed from the interstices of the part in its malleable state, or destroyed by combustion or chemical attack.

### Manufacturing Method

More broadly, the invention also relates to a method for manufacturing at least one part 10 comprising a plurality of thin elements 12 separated by interstices.

According to this manufacturing method, the method for manufacturing said part 10 is an additive manufacturing method and the part thus manufactured is segmented after manufacturing using the segmenting method described above.

The manufacturing method can also make provision for manufacturing a plurality of parts (P1, P2, P3, etc.) comprising a plurality of thin elements separated by interstices, as shown in FIG. 7.

In this case, the manufacturing method makes provision for the additive manufacturing of a single body 40 grouping together the different parts (P1, P2, P3, etc.) to be manufactured, and then for the use of the segmenting method described above in order to segment the different parts from said body. It is thus possible to manufacture a large number of parts from a single production operation. In addition, this variant of the manufacturing method also makes it possible to manufacture parts that are very thin in terms of height, for example just 4 to 8 millimetres in height, and comprising thin elements such as those defined above. More specifically, the invention relates to a manufacturing method in which a part 10 or a body 40 to be segmented is initially manufactured using an additive manufacturing method by powder layer deposition and selective consolidation of each powder layer.

If a part 10 or a body 40 to be segmented is manufactured on a manufacturing plate, said part or said body can still be rigidly connected to its plate during the segmenting thereof. Advantageously, a plurality of parts 10 and/or a plurality of bodies 40 can be manufactured on the same manufacturing plate.

1.-21. (canceled)

22. A method for segmenting a part (10) comprising a plurality of thin elements (12) separated by interstices (30), the thin elements being thin walls (14) with a thickness of less than 1 mm and/or thin strands (24) with a cross-section of less than 4 mm², the method comprising the following steps taken in order:
(a) filling the interstices situated between the thin elements of the part to be segmented with a filling material;
(b) segmenting the part into a plurality of portions by segmenting the thin elements; and
(c) removing the filling material from the segmented portions.

23. The method according to claim 22, wherein the thin elements extend in a same direction without crossing, or
wherein the thin elements extend in the same direction and intersect each other.

24. The method according to claim 22, wherein two adjacent and non-secant thin elements are situated less than 1 mm apart.

25. The method according to claim 22, wherein, when the thin elements are thin walls, a thickness of the thin walls is between 0.05 mm and 0.25 mm, or
wherein, when the thin elements are thin strands, a cross-section of the thin strands being between 1 mm² and 3 mm².

26. The method according to claim 22, wherein the segmenting is carried out using a mechanical tool.

27. The method according to claim 22, wherein the filling material is in a liquid state during step (a) and a solid state during step (b).

28. The method according to claim 27, wherein the filling material passes back to a liquid state during step (c).

29. The method according to claim 28, wherein the filling material passes from a liquid state to a solid state, and conversely from a solid state to a liquid state, under an effect of a temperature change.

30. The method according to claim 29, wherein the filling material has a solidification temperature and a melting temperature of between 45° C. and 100° C.

31. The method according to claim 30, wherein the filling material is wax.

32. The method according to claim 29, wherein the filling material is water.

33. The method according to claim 29, wherein the filling material has a solidification temperature and a melting temperature of between 100° C. and 250° C.

34. The method according to claim 33, wherein the filling material is a low melting point metal or metal alloy.

35. The method according to claim 27, wherein the filling material passes from a liquid state to a solid state through a chemical reaction.

36. The method according to claim 35, wherein the filling material is destroyed during removal of the filling material from the segmented portions.

37. The method according to claim 35, wherein the filling material is a polymerizable resin.

38. The method according to claim 22, wherein the filling material is in a malleable state during step (a) and a solid state during step (b).

39. The method according to claim 38, wherein the filling material is a thermoforming resin.

40. A method for manufacturing at least one part (10) comprising a plurality of thin elements (12) separated by interstices, the thin elements being thin walls (14) with a thickness of less than 1 mm and/or thin strands (24) with a cross-section of less than 4 mm², the method comprising:
manufacturing the part using an additive manufacturing method; and then
segmenting the manufactured part according to the method of claim 22.

41. The method according to claim 40, wherein the method includes manufacturing a plurality of parts and further comprises the following steps in order:
additive manufacturing a single body (40) which groups together different parts to be manufactured; and
using the method of claim 22 to segment the different parts from the body.

42. The method according to claim 40, wherein a part to be segmented is initially manufactured using an additive manufacturing method by powder layer deposition and selective consolidation of each powder layer.
